(19) United States
(12) Patent Application Publication
(10) Pub. No.: US 2003/0121547 A1
(43) Pub. Date: Jul. 3, 2003

(54) Water-excluding valve assembly for a snorkel

(76) Inventor: Douglas M. Aucoin, Monrovia, CA (US)

Correspondence Address: The Law Offices Of Dr. Sharon H. Roddan, Esq., 228 Monarch Bay, Monarch Beach, CA, 92629, US

(21) Appl. No.: 10/033,603

(22) Filed: Dec. 28, 2001

(51) Int. Cl. F16K 21/18

(52) U.S. Cl. 137/388

(57) ABSTRACT

The present invention provides a water-excluding valve assembly for a diving snorkel which can easily be attached to an existing, simple, low cost snorkel giving it features of a more expensive snorkel. This water-excluding valve assembly for a diving snorkel uses a single ball float mechanism to seal off the snorkel airway in the event that the upper end of the snorkel airway tube goes below the water line.

### B. CROSS REFERENCE TO RELATED APPLICATIONS

None

### C. STATEMENT REGARDING FEDERAL SPONSORED R & D

None

### D. REFERENCE TO A “MICROFICHE APPENDIX

None

### E. BACKGROUND OF THE INVENTION

1. Field of the Invention

This invention relates to snorkels, specifically to a water excluding valve assembly which is easily attached to the top of a standard, inexpensive snorkel providing the snorkel with a novel water excluding feature.

2. Description of Related Art

Underwater exploring and fishing through SCUBA diving or snorkeling has long been one of the most popular water sports. While using the most basic of equipment, a mask, fins, and a snorkel, the snorkeler swims just under the surface of the water, face down, and observes a new world under the water.

The snorkel, in its most primitive form, is little more than a tube extending out of the water and into the air above the water surface, and a mouthpiece through which the snorkeler draws air while viewing the underwater sights. Such a basic snorkel as just described usually cost only a few dollars and can be purchased anywhere from dive shops to drugstores and supermarkets.

However, the device as just described, while still a lot of fun for the snorkeler, provides no protection from inadvertent water entry. Many times during snorkeling, the user must stop snorkeling in order to clear the breathing tube of water. This is bothersome. In addition, if a snorkeler dives to a depth deeper than the distance of the breathing tube, the tube always fills with water and requires the snorkeler to stop swimming, resurface and clear the breathing tube of the water in order to further use the snorkel.

Few prior art attempts address an adapter for a snorkel with the express purpose of excluding water. Most prior art attempts to invent “dry” snorkels include snorkels in their entirety and include the breathing tube and mouthpiece of the basic snorkel but may also having multiple airways, flapper type check valves, and separate air inlet and water outlet paths. These are costly and generally reserved for experienced snorkelers. These prior art patents are nothing like the applicants novel water excluding valve assembly for use with a standard, basic snorkel. None of the prior snorkel art describes the simple water-excluding valve assembly of applicant's claimed invention. Applicants novel invention when added to a basic, inexpensive snorkel apparatus converts a “drugstore snorkel” to a more expensive “dry” snorkel and provides simple added features not found in even the more complex and more professional snorkels.

Winefordner, et al., U.S. Pat. No. 5,960,791, teaches a water excluding valve assembly for adding to a basic snorkel. This patent, however, uses a flapper type of valve design. The snorkel airway tube receiving the valve assembly must be facing upward for the flapper valve of the invention to work. The user must remain face down exclusively and the tube must be close to vertical in relation to the horizontal plane of the water for the valve to work properly. If the user is tilted or jostled from side to side causing the tube to tilt (as is typical of snorkeling in rough water) then the flapper valve will open and water will flood the airway passage. This is a definite disadvantage for a snorkeler. This disadvantage has been overcome with applicants novel invention.

Lin, U.S. Pat. No. 5,117,817 teaches a complete snorkel (not just the valve accessory) designed specifically for a complex snorkel assembly The Lin patent is for a multi-tubular, coaxial diving snorkel. The Lin snorkel has separate concentric inlet and outlet airways each having its own diaphragm flapper type check valve. A single float actuates these separate valves. These separate valves will only operate with the coaxial multi-tubular airways. Therefore this configuration is only adaptable to the Lin patent snorkel assembly. The Lin patent is a far cry from applicant's novel invention which may be adapted to fit an inexpensive, basic, single airway snorkel.

Hunt, U.S. Pat. No. 4,805,610, also teaches a complete snorkel having a ball type water excluding valve. The device described in the Hunt patent is large and cumbersome. It uses a ball to close the airway passage that is separate from the float Furthermore, the seat with which the ball works, is part of the airway tube itself, virtually eliminating the valve assembly from being used on any other snorkel.

### F. SUMMARY OF THE INVENTION

### Objective and Advantages

The present invention provides a water-excluding valve assembly for a diving snorkel which can easily be attached to an existing, simple, low cost snorkel giving it features of a more expensive snorkel.

### G. DESCRIPTION OF THE DRAWINGS

The details and many of the advantages provided by this invention will become clear and will be better understood by reviewing the following description and accompanying drawings, wherein:

FIG. 1, is a top perspective view of the present invention, a water-excluding valve assembly for a diving snorkel,

FIG. 1a, is an exploded top perspective view of the present invention (the spherical float element is shown outside the cage for clarity), and

FIG. 2, is an exploded top perspective view of the valve assembly with its cage cut in a half section view.

### H. DETAILED DESCRIPTION

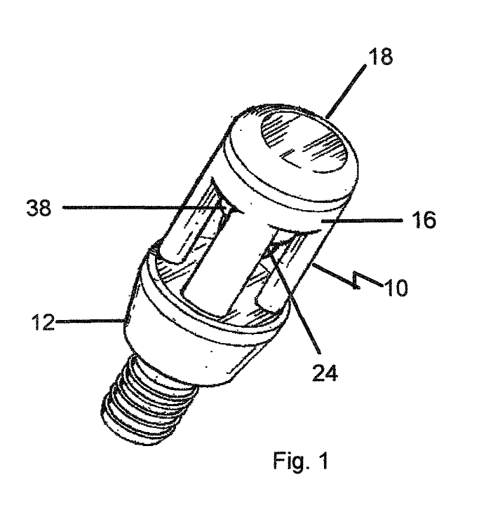

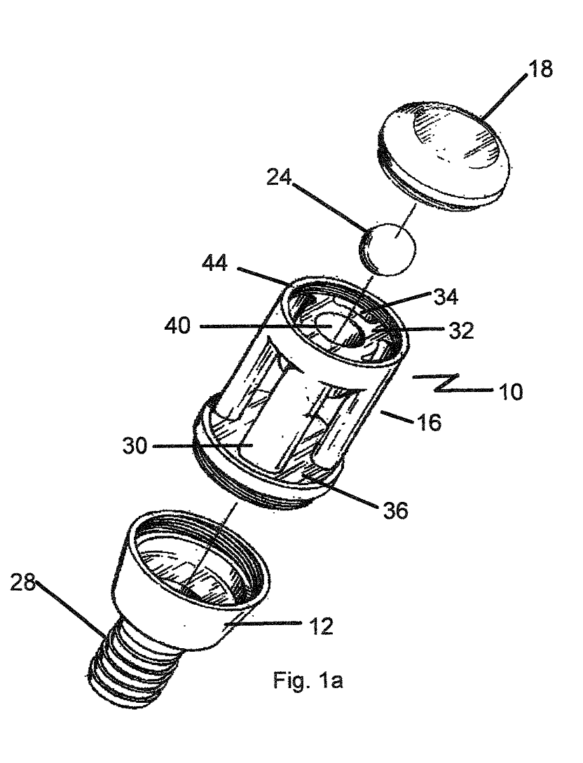

The preferred embodiment of the water-excluding valve assembly for a diving snorkel of the present invention is illustrated in the top perspective view, FIG. 1. For increased clarity, FIG. 1a depicts an exploded top perspective view having the spherical float located outside the cage for clarity only. However, in reality, the spherical float must be inside the cage to practice the invention.

As shown in FIG. 1, the valve assembly 10 of the present invention has a cap 18, a cage 16, a base 12, and a spherical float 24. The cap, cage and base are injection molded of an acceptable material such as for example plastic. The spherical float would be made of an acceptable material having buoyancy such as for example urethane.

The cage 16 is formed by the assembly of an upper piece 32, a lower piece 36 and a plurality of hollow posts 30. As shown in FIG. 1a, the upper piece 32 has a plurality of openings 34 about its circumference and the lower piece 36 has a plurality of openings (not shown) about its circumference. There are a plurality of hollow posts 30 affixed to the upper piece 32 and the lower piece 36 at their respective openings. The assembly of these three components (the upper piece, the posts, and the lower piece) forms the cage 16. A spherical float 24 is captive within the cage 16. Furthermore, the upper piece has a main opening 40 about its centerline axis and protruding from the bottom of the upper piece 32. This main opening forms a ball valve seat 38. In addition, the spherical float 24 is free to move between the ball valve seat opening of the upper piece and the top of the lower piece while trapped within the central chamber of the cage. The spherical float 24 and the ball valve seat 38 form a watertight seal when in communication with one another. A base 12 with a barb 28 completes the valve assembly structure.

The cap 18 in FIG. 1 and FIG. 1a is attached to the upper end of cage 16 by standard means, such as for example threads or cement. Similarly, base 12 is affixed to the bottom end of the cage 16 by standard means, such as for example threads or cement.

When the cap 18 and the upper end of the cage 16 are communicating with one another, the interior space created therein form an upper air chamber. When the lower end of the cage 16 and the base 12 are communicating with one another, the interior space created therein form a lower air chamber. Since the posts of the cage 16 are hollow, they provide airway passages 34 which connect an upper air chamber and a lower air chamber.

The cap 18 is shown in the figures as having a slight dome. This configuration creates a convex interior air chamber within the interior space of the cap and the upper piece. An alternative embodiment would raise the edge of the lip 44 of the upper piece 32 to create a larger air chamber and permit the cap 18 to be a flat disc while still permitting an air chamber to be formed within the interior space of the cap 18 and the upper piece 32. In a like manner, the inventor has contemplated enlarging the lower air chamber. Neither of these alternatives are depicted in the drawings

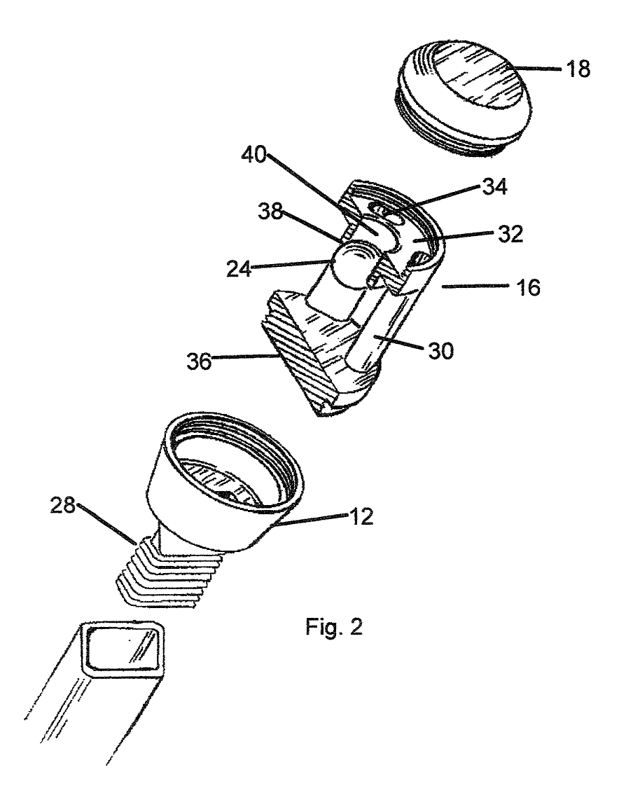

FIG. 2 is an exploded top perspective view of the valve assembly with its cage cut in a half section view. Although the cage 16 having the spherical float trapped within is essential to practicing the invention, the exact configuration for forming the cage may be done in any number of ways. FIG. 2 depicts the cage 16 with an upper piece 32 and a lower piece 36, and a plurality of hollow posts 30 projecting downwardly and located circumferentially around the outer edge of the upper 32 piece forming cage 16, and connecting the hollow posts of upper piece 32 to the matching openings in lower piece 36. In alternative embodiments, the length of the posts may be split equally or unequally between the upper piece and the lower piece and mated together. The best embodiment the inventor has determined is to die cut the hollow posts of equal length. In other words, one-half of the length of the hollow posts are projecting downwardly from the upper piece and one-half of the length of the hollow posts are projecting upwardly from the lower piece.

Since the posts are hollow, they provide airway passages 34 which connect an upper chamber and a lower chamber. Within the cage 16, a spherical float 24 is held captive between the posts 30, and is allowed to freely move between the lower piece 36 at its lower end and the upper piece 32 at its upper end. A main opening 40 located about the central axis of the upper piece 32 provides a passage into the upper chamber from outside the valve assembly. A float seat 38 is formed by the main opening 40 as a means for receiving the spherical float when it is in its upper most position, thereby sealing the passage. In normal use, when the valve assembly 10 is immersed under water, the spherical float 24 will float to its upper most position and firmly engage the float seat 38, thereby shutting off the passage and preventing water from entering the passage. FIG. 2 shows a lower piece 12 with a soft rectangular shaped tube barb 28 needed to adapt to soft rectangular shaped snorkel airway tubes.

In FIG. 1 and FIG. 1a, the base 12 has at its lower end a hose barb 28 which is round and sized to fit inside a typical round snorkel tube in the preferred embodiment As an alternative embodiment, hose barb 28 may be rectangular in shape to fit inside a typical rectangular snorkel tube. As a third embodiment, the hose barb may be triangular in shape to fit inside a typical triangular snorkel tube.

To manufacture, one must begin with tooling and molding the five component parts, (1) the cap, (2) the upper piece with or without hollow posts projecting therefrom, (3) the lower piece with or without hollow posts projecting therefrom, (4) a base with a barb, and (5) a floating sphere. After the component parts are made and assembled, the cap is affixed to the upper piece. The upper piece is affixed to the lower piece. This is done by mating the upper hollow posts or openings with the lower hollow posts or openings. One must use care at this time to trap the spherical float within the interior space of the “cage” (which has been formed by the union of the upper piece, the lower piece, and their connecting hollow posts.) The base is affixed to the bottom of the lower piece and the simple assembly of the water-excluding valve is completed. With the exception of trapping the sphere within the cage, the order of the assembly of the component parts is not essential to practice the invention.

To use the device, one simply inserts the barb of the device into the opening of a standard snorkel tube and swims on the surface of the water while peering downwardly into the water below.

What is claimed is:

1. A water-excluding valve assembly for a diving snorkel, comprising:
a cap;
an upper piece with a top and a bottom and having a plurality of longitudinally spaced openings about its circumference;
a lower piece with a top and a bottom and having a plurality of longitudinally spaced openings about its circumference;
a plurality of hollow, longitudinal posts in communication with said upper piece and said lower piece at their longitudinally spaced openings;
the assembly of said upper piece, said lower piece and said posts forming a cage;
a spherical float, said spherical float being held captive within said cage;
said upper piece having a main opening about its centerline axis, said main opening forming a ball valve seat;
said cap and said top of said upper piece in communication and forming there between an upper air chamber;
a base, said base having a top and a bottom and having a main opening about its centerline axis;
said top of said base and said bottom of said lower piece in communication and forming there between a lower air chamber;
a hose barb located at said bottom of said base.

2. The water-excluding valve assembly for a diving snorkel as set forth in claim 1 wherein the hose barb is of a round shape.

3. The water-excluding valve assembly for a diving snorkel as set forth in claim 1 wherein the hose barb is of a rectangular shape.

4. The water-excluding valve assembly for a diving snorkel as set forth in claim 1 wherein the hose barb is of a triangular shape.
